(19) United States
(12) Patent Application Publication
(10) Pub. No.: US 2005/0057424 A1
(43) Pub. Date: Mar. 17, 2005

(54) Planar antenna

(76) Inventors: Vesa Kukko, Tampere (FI); Heikki Ahokas, Tampere (FI)

Correspondence Address: FITCH EVEN TABIN AND FLANNERY, 120 SOUTH LA SALLE STREET, SUITE 1600, CHICAGO, IL, 60603-3406, US

(21) Appl. No.: 10/889,454

(22) Filed: Jul. 12, 2004

Related U.S. Application Data
(60) Provisional application No. 60/486,054, filed on Jul. 10, 2003.

(51) Int. Cl. H01Q 1/40

(52) U.S. Cl. 343/873

(57) ABSTRACT

Fabricating planar antenna by incorporating text or graphical images into the conductive part of the antenna.

This application claims the benefit of U.S. Provisional Application 60/486,054 filed Jul. 10, 2003 which is hereby incorporated by reference herein.

### BACKGROUND OF THE INVENTION

The present invention relates to a planar RF transmitting and receiving antenna.

Radio Frequency Identification (RFID) systems are generally known and used to identify objects such as commercial products, i.e., circuit boards, and units for combining commercial products such as pallets for moving large numbers of products. RFID systems include an RFID-transponder attached to items to be identified and an interrogator for receiving communications from the transponder and possibly for transmitting data to the transponder.

An RFID-transponder comprises a RF signaling device, e.g., receiver/transmitter, which may store data and an antenna for radiating RF signals from the receiver/transmitter. It is desirable to keep the size of the RFID receiver/transmitter as small as possible and, accordingly, the antenna is often a planar antenna printed or otherwise produced on a small thin substrate. Frequently, the antennas are dipole antennas but other antenna configurations may be used.

RFID-transponders are frequently used on products which also bear images or text, e.g., company logos which may also be produced on the substrate. The production of images and text as well as a RFID antenna on a substrate often necessitates multiple processing steps. A need exists for methods and apparatus for producing RFID antenna and text and images without the need for multiple fabrication steps.

In accordance with the methods and apparatus described herein multiple processing steps are avoided by fabricating an antenna having a customized visual appearance in a single process. The visual appearance comprises incorporating visual elements into the antenna and using those visual elements to fine tune the RF characteristics of the antenna.

### BRIEF DESCRIPTION OF THE DRAWINGS

FIG. 1 shows a planar antenna including a landscape visual characteristic;

FIG. 2 shows a planar antenna including a truck and trailer as visual characteristics;

FIG. 3 shows a planar antenna including text as a visual characteristic;

FIGS. 4 and 5 illustrate the real and imaginary impedance characteristics of a dipole antenna and of the antennae of FIGS. 1 and 3;

FIG. 6 illustrates the impedance characteristics of a dipole antenna;

FIGS. 7 and 8 illustrate the impedance characteristics fo the text antenna of FIG. 3 and the landscape antenna of FIG. 1 respectively;

FIGS. 9-11 illustrate the layout, composition and fabrication of a text bearing dipole antenna;

FIGS. 12 and 13 illustrate the impedance and radiation characteristics of the antenna of FIG. 9;

FIGS. 14D are tables showing the electrical characteristics of the antenna of FIG. 9; and

FIGS. 15 illustrates a coil type antenna having a shape of Finland.

### DESCRIPTION

Many RFID end-users or system integrators desire that RFID-transponders for different applications have visually clearly distinguishable differences in their appearance. Product suppliers also want to have a unique layout for universal use in supply chain and retail. A problem is that additional process steps in transponder manufacturing to include both unique layout and a separate antenna increase the costs of a transponder. By manufacturing the visual elements with the same process as the antenna, additional process steps are avoided. However, additional metal areas and/or shapes in proximity to antenna may impair the performance of the antenna. On the other hand, various bars, blocks, corners, bends, loops, etc. are commonly used for the fine tuning of the impedance of the antennae. Fine tuning is needed when antenna is matched up to a controlling micro-chip.

The general object of the invention is to provide a RFID-transponder that has distinguishable customized visual appearance and achieves known electrical properties. A specific object is to minimize the disadvantages of customized antenna layout design on the technical performance of the transponder. Another specific object is providing fine tuning of the antenna by using visual elements.

In the present invention the impedance tuning elements of planar RFID-transponder antenna are utilized for providing distinguishable customized transponders. The size, shape and location of tuning elements are arranged in such a way that they provide desired visual appearance and technical characteristics. Furthermore, shaping of the antenna by bending antenna baseline and varying the line width can be used for visual layout design with or without the tuning elements. As a result of this, for example, a manufacturer could have antennae that have the shape of company name or logo.

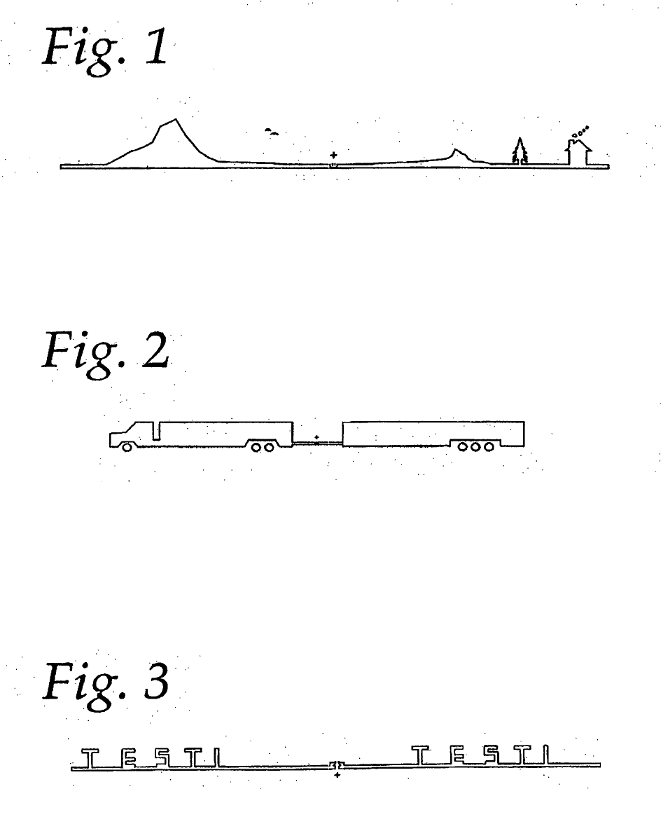

FIGS. 1, 2 and 3 show examples of dipole antennae with distinguishable visual appearance. Almost any shapes can be added to the dipole antennae. Coarse tuning of the electrical characteristics of the antenna is first determined by varying antenna length and line width. Then visual tuning elements visual elements to be added to the antenna are also determined. Finally, the effect on the impedance and other antenna characteristics is calculated and fine tuning made by varying size, shape and locations of the visual elements and the length and line width of a baseline.

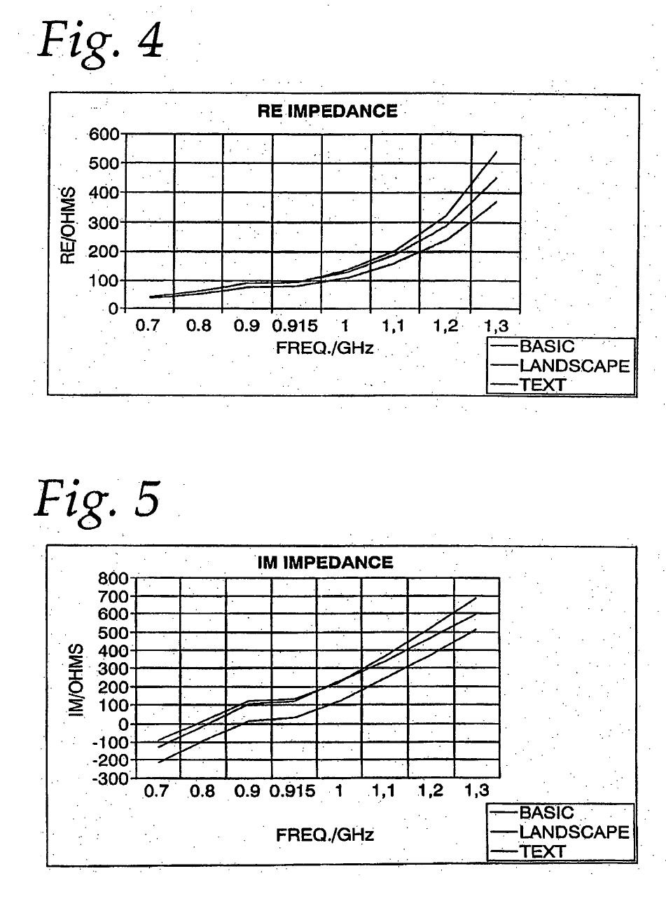

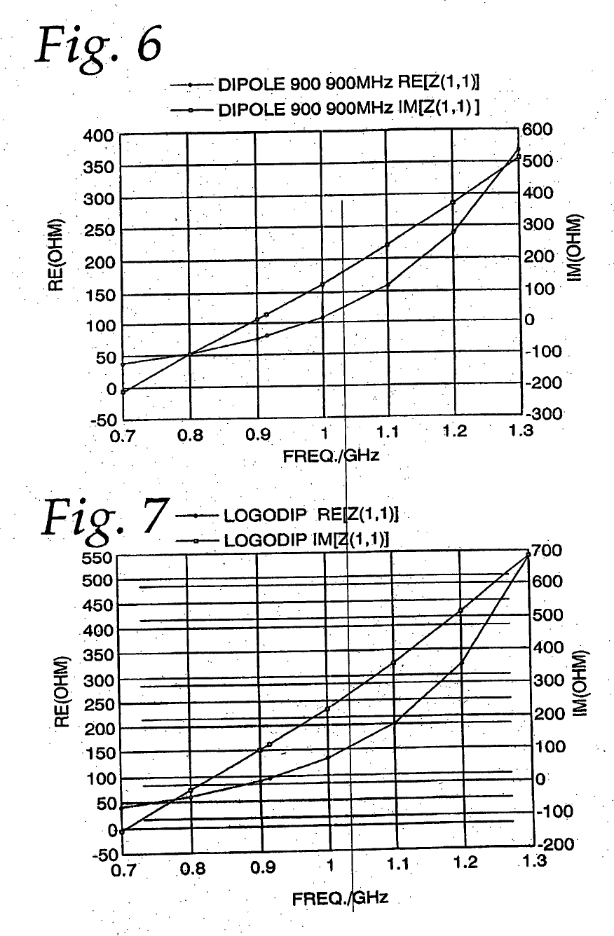

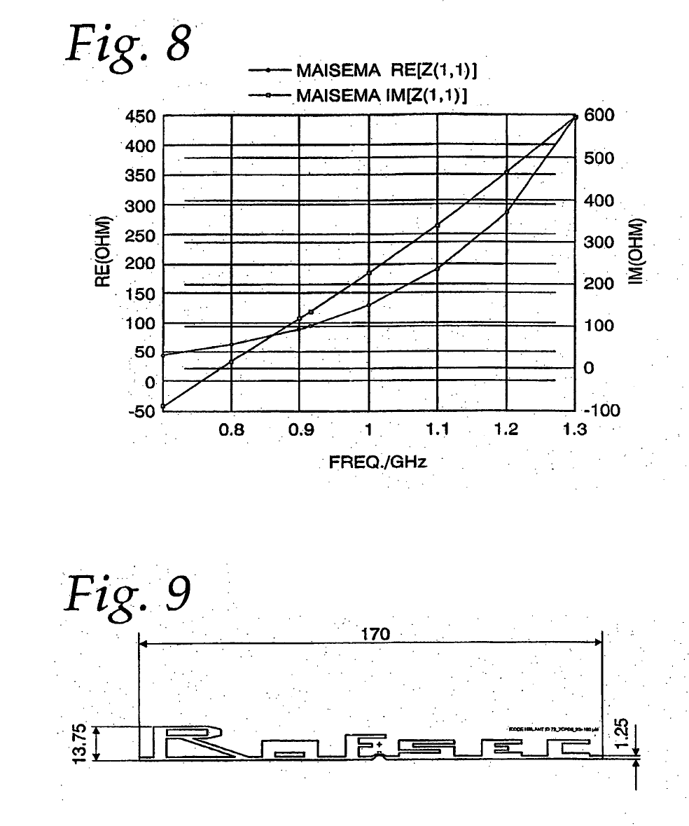

FIG. 1 shows a “landscape” and FIG. 2 shows a “truck” layout design as an example. Letters can be easily used for antenna layout customizing, as shown in FIG. 3. FIGS. 4-8 show the results of impedance simulations for antennae in FIGS. 1 and 3 and a straight line basic dipole for comparison. These antennae could be used with a High Frequency Smart Label (HSL) chip which would be located in the middle of antenna.

The examples above are dipole type antennae, but as well the tuning elements and shaping could be used for customizing the visual appearance of other antenna types. For example, circular or coil antenna could have contour of the map of Finland or any other graphical image. This would also provide different radiation patterns for antenna than circular antenna and at the same time provide a visually desired result.

Antenna may be fabricated by determining the size and shape of the basic antenna then the shape and placement of the visual elements on the basic antenna. The representations and placement of the basic antenna and the visual elements are then combined into a single circuit layout. A single conductive layer, such as metalized film, is then formed on a substrate such as polypropylene or polyethylene in the shape of the combined profile. Advantageously, the graphical portion of such a circuit may be formed in reverse on a transparent or translucent substrate to form a tag or label. When the steps are performed, a RFID antenna can be fabricated having appropriate electrical (RF) characteristics and which presents the desired visual image or text. Design tools are generally available for selecting basic physical characteristics for antenna and for approximating the effects of additions to the antenna such as cross members and stubs. One such design tool is the IE3D software package available from Bay Technology and Zeland Software.

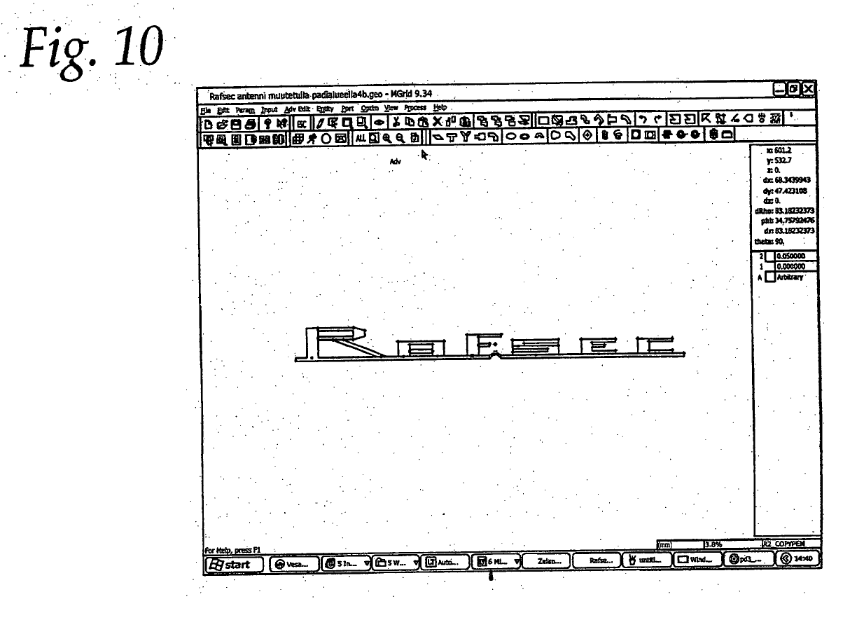

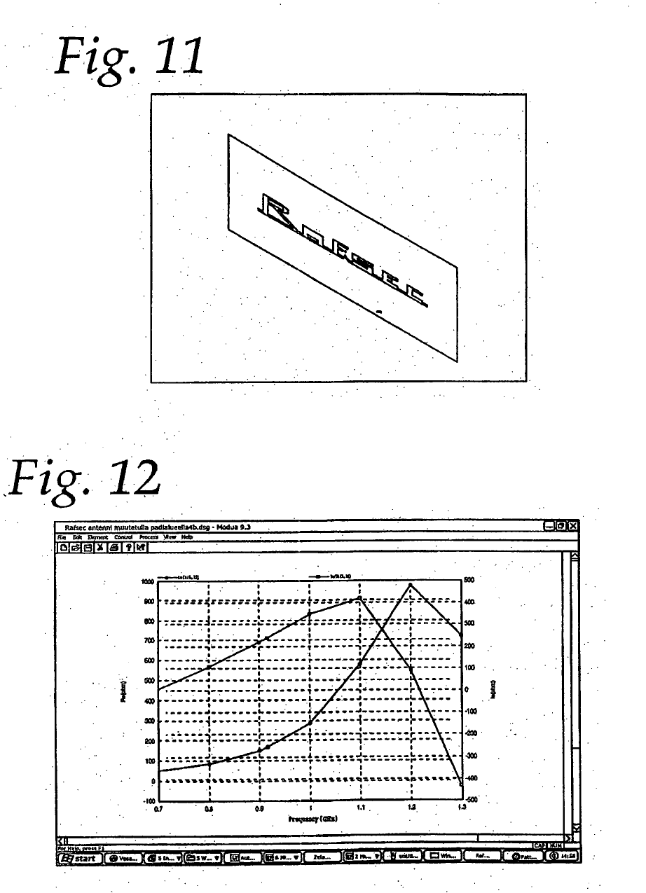

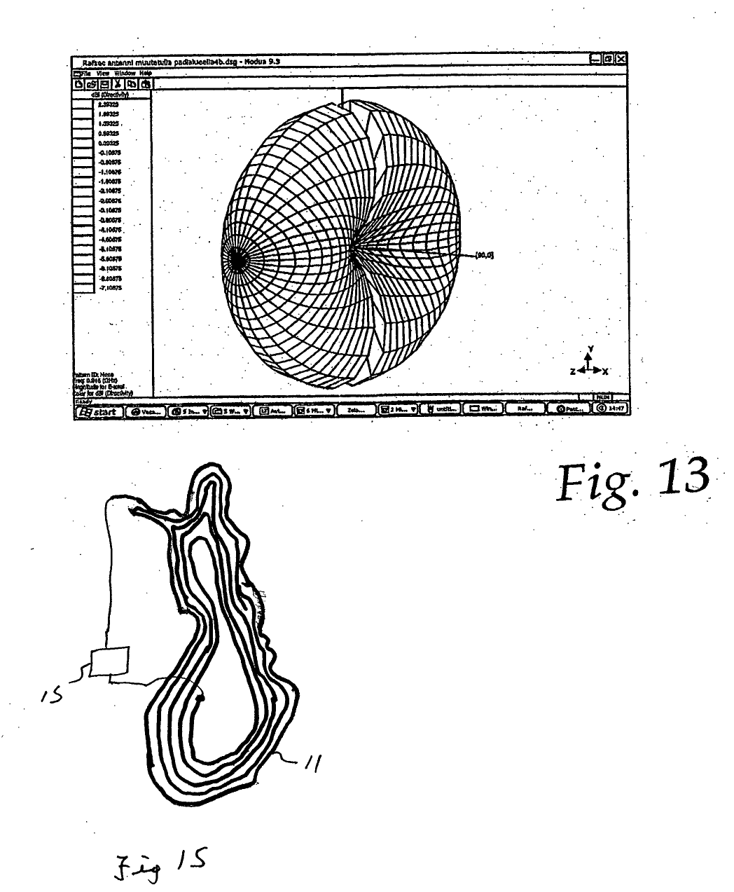

At the beginning of an antenna design, the designer establishes the electrical properties (RF) to be achieved as well as the graphical properties to be visually presented. In the present example, the designer needs a half wave dipole antenna for operation at 915 MHZ. The materials to be used are also selected at this time and, in the present example, the designer chooses to use a transparent PET substrate of 50 μm. The antenna conductors are also selected to be of etched copper foil at 18 μm to be formed on the PET substrate. The graphical representation is selected to be the text word RAFSEC and the desired font for such is as shown in FIG. 9.

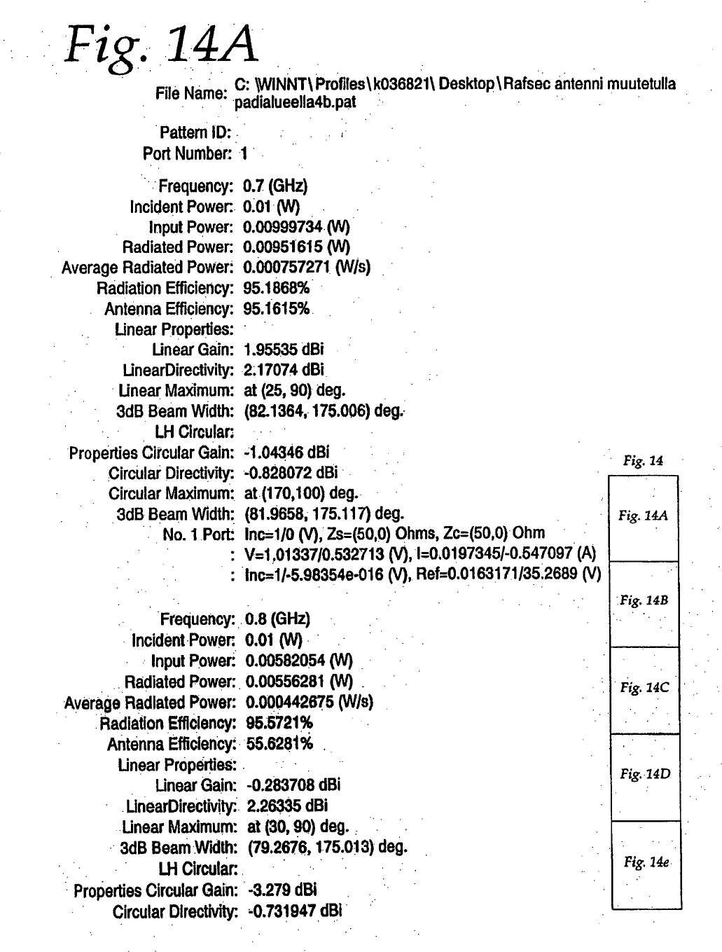

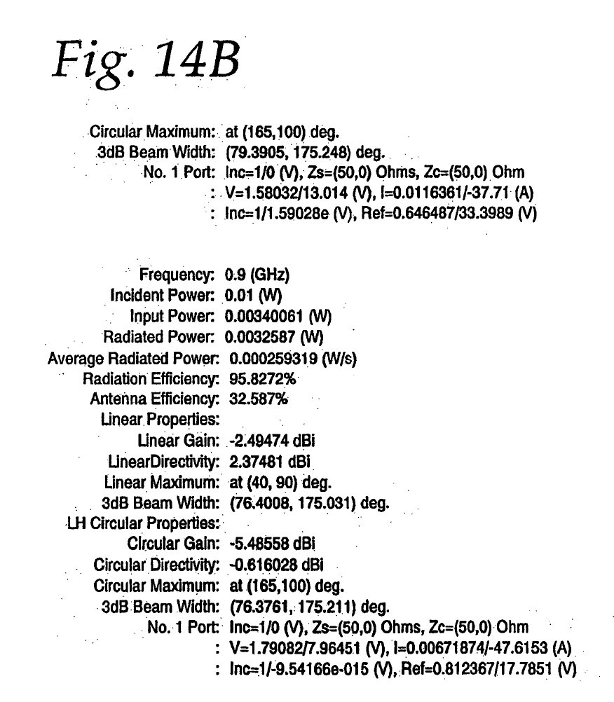

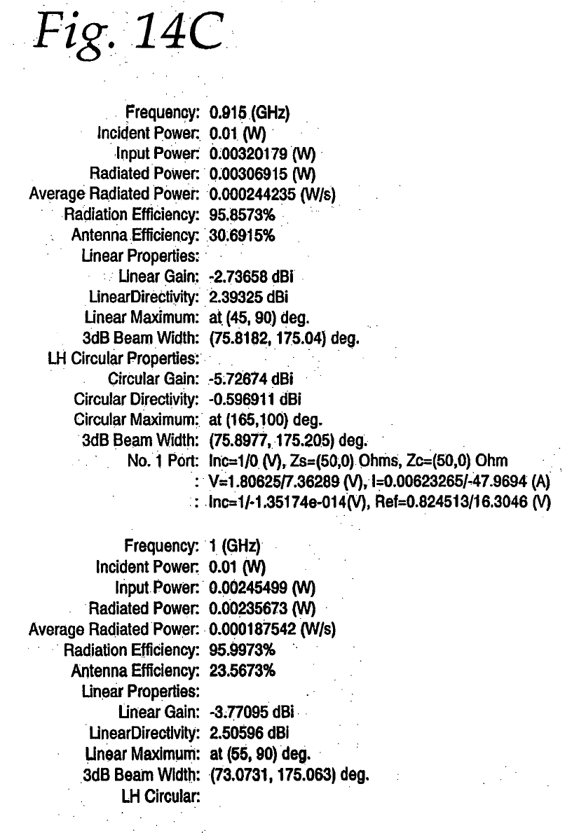

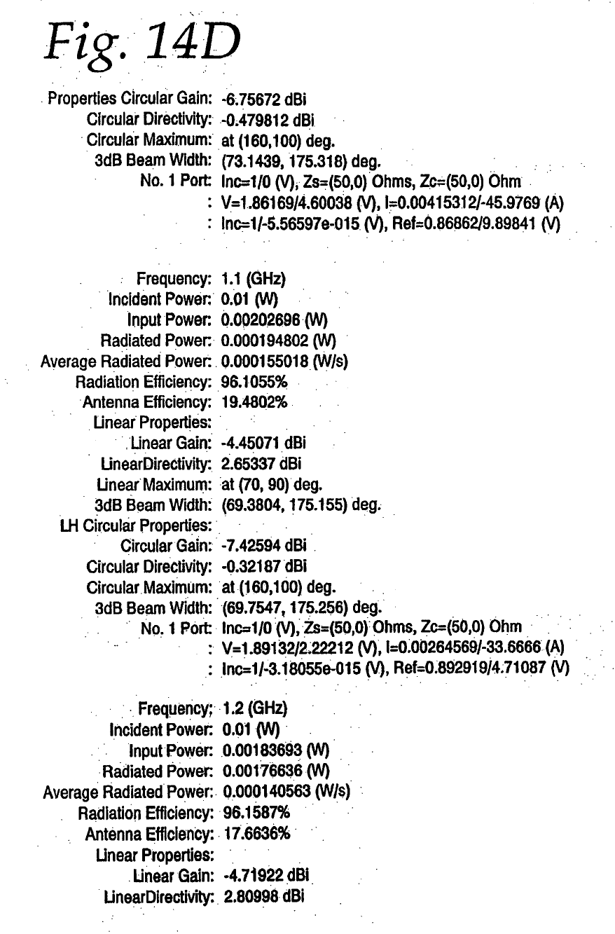

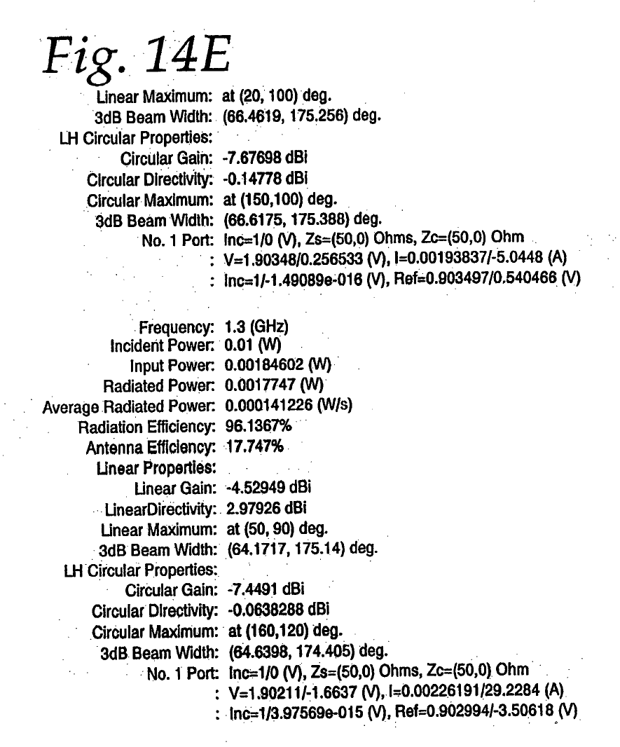

The antenna designer, enters the desired text and design characteristics into the graphical interface of an antenna design/simulation program such as the above mentioned IE3D program. The approximate dimensions of the antenna components are entered based on common antenna design techniques. In the present example, a dipole antenna length of 170 mm is selected, based on the 915 MHZ operating frequency. An operating simulation is next performed using the simulation program. The results of the simulation are then analyzed to determine the suitability of the simulated antenna for its intended purpose. Such results for the antenna of FIG. 9 are shown in FIG. 14A-E and particularly in FIG. 14C with regard to operation at 915 MHZ. When the simulation results are satisfactory, the design parameters can be used to fabricate an actual antenna which can be tested. In the present example, the antenna/logo is to be visible through the PET substrate so the antenna is fabricated in reverse on the substrate and testing is done through the PET substrate. Alternatively, when simulation results are not as desired the graphical representation and/or general dimensions of the antenna may be changed and re-entered into the graphical interface of the simulation program. The process may thus be an iterative one which continues until satisfactory results are achieved.

The above example relates to the design and fabrication of a dipole antenna bearing text. FIG. 15 shows the possible fabrication of the map of Finland using a coil or spiral type antenna. In that figure, the line 11 traces the outline of Finland and spirals inwardly. The free ends of line 11 may be connected to a microchip 15 as is well known in the art. The design and layout of the coil type antenna is the same as discussed above regarding the dipole. The traced lines of the representation are entered into the graphical interface of the simulation program and simulations are run to test performance. When satisfactory performance is achieved the antenna can be fabricated. Alternatively, if a simulated antenna is not correct, the parameters, such as line width and spacing can be changed and a new simulation performed until the desired results is achieved.

The drawings and the foregoing descriptions are not intended to represent the only forms of the invention in regard to the details of its construction and manner of operation. Changes in form and in the proportion of parts, as well as the substitution of equivalents, are contemplated as circumstances may suggest or render expedient; and although specific terms have been employed, they are intended in a generic and descriptive sense only and not for the purposes of limitation, the scope of the invention being delineated by the following claims.

1. A planar RF antenna comprising:
a conductive layer formed on a substrate and including visual elements as a part of the conductive layer of the antenna.

2. A planar antenna in accordance with claim 1 wherein the size and placement of the visual elements are used to tune the RF characteristics of the planar antenna.

3. A planar antenna in accordance with claim 1 wherein the visual elements comprise text.

4. A planar antenna in accordance with claim 1 wherein the visual elements comprise graphical representations.

5. A method of fabricating a RF planar antenna including graphical representations on a substrate comprising:
determining the basic physical characteristics of an antenna to nominally tune the RF characteristics of the antenna;
determining the shape and placement of graphical representations to achieve the basic physical characteristics and to fine tune the RF characteristics of the antenna; and
fabricating a conductive layer on a substrate having the basic physical characteristics of the first determining step and including the graphical representations shaped as determined the second determining step at locations determined by the second determining step.

6. A method according to claim 5 wherein the fabricating step comprises fabricating the antenna on a substantially transparent substrate.

7. A method according to claim 5 wherein the antenna is a coil type antenna and the placement of graphical representations comprises tracing the outline of a graphical representation using a conductor and spiraling inwardly therefrom during the fabrication step.

8. A method of designing a planar antenna having text representations comprising:
identifying RF characteristics of a desired antenna;
determining the basic physical characteristics of a dipole antenna to achieve the RF characteristics;
graphically entering into an antenna simulator an antenna having the basic physical characteristics and including representations of text;
performing a simulation of the entered antenna; and
re-entering a modified antenna into the antenna simulator when the performing step shows RF characteristics significantly different from the identified RF characteristics.

9. A method of claim 8 comprising fabricating a dipole antenna in accordance with the simulated antenna when the performance of the simulation shows RF characteristics within a predetermined range of the identified characteristics.
